(19) United States
(12) Patent Application Publication
(10) Pub. No.: US 2003/0237082 A1
(43) Pub. Date: Dec. 25, 2003

(54) System for installation of print driver software

(75) Inventor: Barry J. Thurlow, Luton (GB)

Correspondence Address: Patent Documentation Center, Xerox Corporation, 100 Clinton Ave. S., Xerox Square 20th Floor, Rochester, NY, 14644, US

(73) Assignee: Xerox Corporation

(21) Appl. No.: 10/176,447

(22) Filed: Jun. 20, 2002

(51) Int. Cl. G06F 15/16; G06F 9/445

(52) U.S. Cl. 717/176; 709/206

(57) ABSTRACT

What is disclosed is a system and method which enable a user of a networked device to communicate with the device by email and to receive a reply thereto which contains the installation software which assists the user to facilitate device setup and configuration prior to the subsequent operation thereof. The method involves a user first sending or otherwise initiating an email to a remote device such as a printer. In the alternative, the printer device gains access to one or more end user's email addresses. Once obtained, the printer device automatically sends a reply email back to the user, preferably with a greeting or other message, with a package attached thereto or otherwise associated therewith containing installation software along with other configuration software and tools. Upon receipt of the installation package from the printing device, the end-user would click on the installation software, or preferably, an installation wizard or other interface program with preset defaults would guide the end-user through installation process. The software would query the end-user's computer to understand the computer's configuration. The necessary modifications and/or configuration changes to the end-user's computer would occur sufficient to allow the end-user to operate the networked remote printer device therefrom. Thereafter, the networked printing device would be ready for use from that user's computer.

### RELATED CASES

Cross reference is made to the following application filed concurrently: Attorney Docket Number D/A1484 entitled “SYSTEM FOR INSTALLATION OF PRINT DRIVER SOFTWARE” by Barry J. Thurlow.

### FIELD OF THE INVENTION

The present invention is directed to systems and methods for installing driver software and configuring a networked device from a desktop computer and, in particular, to those systems and methods which enable a user of a networked device to communicate with the device by email and to receive a reply thereto which contains the installation software which assists the user to facilitate device setup and configuration prior to the subsequent operation thereof.

### BACKGROUND OF THE INVENTION

In the arts, devices (such as a printer or copier) can be networked to a plurality of end-users who can send documents to the device from their desktop computer. One awkward and often time consuming tasks associated with the arrival and installation of such a new device is that of installing the requisite driver software. Such drivers are known in the arts and are software applications which make a device visible to the users thereby allowing communication therebetween and which make the newly installed device usable via the desktop computer.

What makes this device installation process particularly troublesome is that many devices, even those from the same manufacturer, often require different drivers which when installed enable various features and capabilities associated with a particular device. In order to get the printer device up and running on a large organization's network, users must first find the correct driver file(s) and thereafter properly load the driver software onto their desktop computer. The process can at times be user-unfriendly and prone to error. To complete the driver software installation it may also require the user to know certain information about the printer such as it's network name, IP address, installed options, features, and so on. It can be a frustrating process at times for some users who are relatively unfamiliar with the driver software installation process thereby requiring the assistance of others more knowledgeable about software installation.

What is known in the arts are systems (such as the Xerox 6085) which use a method whereby an icon associated with the installed device is distributed by email from a system administrator (or other users) to those who are networked to the device and who need the driver software installed on their computer to properly communicate with the newly installed device. Once a user receives the icon, they click on it to install the software or they could thereafter drag and drop documents which are intended for that device onto the icon thereby enabling the use of the device from their computer.

What is needed in this art is a method by which the installed device itself emails the necessary files and/or driver software to the networked users thereby empowering them to easily and conveniently setup the networked device on their respective computers without the help or assistance of others.

### SUMMARY OF THE INVENTION

What is disclosed is a system and method which enable a user of a networked device to communicate with the device by email and to receive a reply thereto which contains the installation software which assists the user to facilitate device setup and configuration prior to the subsequent operation thereof. The method involves a user first sending or otherwise initiating an email to a remote device such as a printer. In the alternative, the printer device gains access to one or more end user's email addresses. Once obtained, the printer device automatically sends a reply email back to the user, preferably with a greeting or other message, with a package attached thereto or otherwise associated therewith containing installation software along with other configuration software and tools. Upon receipt of the installation package from the printing device, the end-user would click on the installation software, or preferably, an installation wizard or other interface program with preset defaults would guide the end-user through installation process. The software would query the end-user's computer to understand the computer's configuration. The necessary modifications and/or configuration changes to the end-user's computer would occur sufficient to allow the end-user to operate the networked remote printer device therefrom. Thereafter, the networked printing device would be ready for use from that user's computer.

### DETAILED DESCRIPTION OF THE INVENTION

What is disclosed is a system and method which enable a user of a networked device to communicate with the device by email and to receive a reply thereto which contains the installation software which assists the user to facilitate device setup and configuration prior to the subsequent operation thereof.

Once driver software for a networked printer device has been installed on an end-user's computer then that end-user can thereafter communicate with that particular printing device. In other words, the end-user can send documents to be printed by the networked printer and subsequently retrieve the printed copies from the printer's output paper tray. It should be understood that although the discussion herein of networked devices refers to printer devices, it is the intention herein that the present invention also find its uses in instances wherein other types of devices capable of network communication with remote users such as copiers and faxes, to name a few.

Although communication by reply email and installation software are known in the arts, it should be understood that the system and method of the present invention is specifically directed toward the novel concept of a remote networked device (such as a printer) communicating by email to one or more networked users. The communication containing certain software and other configuration information about the device and its features. In addition, installation software is attached thereto sufficient to enable the remote user to, upon receipt thereof, install the necessary software and other drivers such that the remote device can then be operated from the user's device.

The method involves a user first sending or otherwise initiating an email to a remote device such as a printer. In the alternative, the printer device gains access to one or more end user's email addresses. Once obtained, the printer device automatically sends a reply email back to the user, preferably with a greeting or other message, with a package attached thereto or otherwise associated therewith. The package contains installation software along with other configuration software and/or tools. Upon receipt of the installation package from the device, the end-user would click on the installation software, or preferably, an installation wizard or other interface program with preset defaults would guide the end-user through the installation process. The software would query the end-user's computer to understand that specific computer's setup and/or configuration. The necessary modifications or configuration changes to the end-user's computer would then be made sufficient to enable the end-user's computer to operate the networked remote device therefrom. Thereafter, the networked device would be ready for use by that user.

With regards to the system of the present invention, the computer network system is in communication with a remote networked device which the user needs to access or otherwise make use of from their desktop or laptop computer in network communication therewith. Both the remote device and the user's computer have email capability either directly there between or through the use of a server configured for this purpose. In the alternative, a database of email addresses is also envisioned herein which is accessible by the remote device. At the console of the remote device, the user enters the email address of their networked desktop or laptop computer intended to access the remote device. The remote device, once having gained access to or knowledge of a end-user's email address, thereafter sends to that email address a message, preferably a greeting of sorts, with an attachment containing the necessary software tools which enable the user to configure their desktop or laptop computer for subsequent operation, access, and/or control from the remote device networked therewith. The user then either through a wizard or other interface, thereafter runs the associated software tools. The software scans the user's computer so as to understand that computer's configuration. The software then modified or adapts the user's computer's configuration and configure such that, upon completion thereof, the user's computer can access or otherwise operate the end device from that desktop or laptop computer.

What is novel herein is the combination of elements. Specifically, a remote device having email capability being networked with at least one end-user's computer also having email capability. The end user entering into the remote device their respective email address. In the alternative, the remote device accesses a database of email addresses. The remote device, once obtaining the end-user's email address, thereafter sending to that email address a package of software (or an email with an attachment therewith). The software package being activatable by the user or, in the alternative, automatically activatable upon opening or upon receipt. Preferably, the software package has a wizard-type interface conveniently minimizing inputs from the user. The wizard then scans the user's computer to understand the specific configuration thereof. Then, setting up the computer such that it can thereafter work with or otherwise operation or control the remote device.

Since there is no need for the user to know any technical details about the network, remote device, or their own desktop or laptop computer, the process advantageously removes the necessity for having Information Technology (IT) Staff on hand. This results in increased customer (or end-user) satisfaction and empowerment. In addition, the present invention increases the speed with which new end-users can access newly installed network office equipment. This has the benefit of potentially increasing sales of such equipment and other similarly enabled consumables. Further, since the equipment to be installed already has the software tools necessary for installation thereof, the present invention further reduces the probability of problems arising from the end-user's not having all the software necessary to configure their desktop or laptop computers.

While the invention is described with reference to a particular embodiment, this particular embodiment is intended to be illustrative, not limiting. Various modifications may be made without departing from the spirit and scope of the invention as defined in the amended claims. Modifications and alterations will occur to others upon reading and understanding this specification; therefore, it is intended that all such modifications and alterations are included insofar as they come within the scope of the appended claims or equivalents thereof.

What is claimed is:

1. A system which assists an end-user to facilitate setup and configuration of a remote device having email capability, said system comprising:
a) at least one end-user computer having email capability;
b) a network enabling communication between said remote device and said end-user's computer;
c) an data entry interface associated with said remote device such that said end-user can enter into the remote device an email address of their computer;
d) at least one device installation software package accessible by said remote device;
e) email reply capability associated with the remote device which, upon gaining access to the end-user's email address, will send to that address an email with said installation software package attached thereto; and
f) operating system associated with said end-user's computer having sufficient enabling capability such that, upon receipt of the email and installation software from said remote device, thereafter enables the installation software to setup and configure the user's computer for subsequent operation of the remote device.

2. A system as defined in claim 1 wherein the remote device is associated with a database containing email addresses of users networked therewith such that the user's don't have to personally enter their respective email addresses into the remote device in order to initiate the email response containing the installation software package.

3. A system as defined in claim 1 wherein said data entry interface comprises a keyboard and terminal.

4. A system as defined in claim 1 wherein said data entry interface comprises a touch screen display.

5. A system as defined in claim 1 wherein said email reply capability associated with said remote device further comprises a server with email send/receive capability.

6. A system as defined in claim 1 wherein email sent by said remote device provides a web-link to said installation software package thereafter downloadable by the end-user.

7. A system as defined in claim 1 wherein said remote device forwards said email address to an other device which in turn makes the installation software package accessible to the end-user.

8. A system as defined in claim 7 wherein said installation package configures the end-user's computer from a remote location via the network over which the end-user's computer communicates.

9. A system as defined in claim 1 wherein said remote device comprises office equipment such as printers, faxes, copiers and scanners.
